(19) United States
(12) Patent Application Publication
(10) Pub. No.: US 2026/0090552 A1
(43) Pub. Date: Apr. 2, 2026

(54) LIME INCORPORATED CHITOSAN - A GREEN FOOD PRESERVATIVE FOR FRUIT JUICES

(71) Applicant: Khalifa University of Science and Technology, Abu Dhabi (AE)

(72) Inventors: Fawzi Banat, Abu Dhabi (AE); Rambabu Krishnamoorthy, Abu Dhabi (AE); Abdul Hai, Abu Dhabi (AE)

(21) Appl. No.: 18/899,319

(22) Filed: Sep. 27, 2024

(51) Int. Cl. A23L 3/358; A23L 3/3562; C08B 37/08

(52) U.S. Cl. CPC A23B 2/788; A23B 2/779; C08B 37/003

(57) ABSTRACT

Lime-incorporated chitosan (LCh) beads are a non-toxic, environmentally friendly, and efficient preservative for food products, showcasing their superiority in microbial control, alcohol inhibition, color retention, and maintenance of physicochemical parameters. The all-natural LCh beads described here exhibit an on-par preservation performance with synthetic sodium benzoate at its maximum permissible limit in fruit juices. Additionally, the LCh beads offer the unique advantage of reusability, maintaining their preservation efficacy over multiple fruit juice preservation cycles, contributing to economic and environmental sustainability. The all-natural and biodegradable LCh beads exhibit comparable or superior preservation performance to synthetic preservatives like sodium benzoate at its maximum permissible limit in fruit juices. In light of the growing concerns about the harmful effects of synthetic preservatives, LCh beads present an eco-friendly and biocompatible solution, aligning with the increasing consumer demand for fresh and safe foods without chemically synthesized additives.

### BACKGROUND OF THE INVENTION

Consumer preference for fresh and unpasteurized fruit juices can be attributed to their nutritional profile, characterized by low levels of sodium, cholesterol, and fat, coupled with elevated concentrations of essential compounds such as vitamin C, polyphenols, and antioxidants. However, the inherent susceptibility of fruit juices to microbial, enzymatic, and chemical deterioration (such as fermentation) poses a significant hurdle, impacting their shelf life [1,2]. The historical reliance on synthetic antimicrobial agents for food preservation, especially for fruit juices, is evident in the widespread adoption of chemical additives like sodium benzoate and potassium sorbate to preserve the original nature and extend the shelf life of these products [3]. However, heightened awareness of the detrimental health effects associated with synthetic agents has spurred efforts to curtail their use. Notably, there is a concerning trend in food industries regarding the evolving yeast resistance to presently utilized weak-organic acid preservatives [4]. Consequently, there is a growing interest in identifying natural and efficient fruit juice preservatives. This shift in preference is also closely linked to consumer demands for fresh, chemical-free foods, driving the exploration and utilization of food preservatives sourced from natural origins. This paradigm aligns with the increasing incorporation of natural agents, encompassing antimicrobials, vitamins, anti-browning agents, and probiotics, to augment the preservation and fortification aspects of freshly squeezed juices [5,6].

Calcium oxide (commonly known as lime) demonstrates notable adsorption characteristics, antimicrobial effects, and biocompatibility, qualifying it as a functional biofiller for integration into food packaging materials [7]. Lime (CaO), in its general application, stands out as an eco-friendly substance and, within specified concentrations for food processing, poses no toxicity concerns for human consumption, having received regulatory approval as a permissible food additive [7,8]. Its efficacy as a functional ingredient for preventing fermentation in food and fruit juice products has undergone extensive scientific investigation [9]. On the other hand, chitosan, a natural cationic linear polysaccharide obtained from diverse natural sources such as crustacean exoskeletons, mushrooms, silkworm chrysalis, and microorganisms, is widely acknowledged for its renewable preservative attributes, encompassing safety, intrinsic antimicrobial effects, compatibility, antioxidative activities, and edibility. The recognized safety profile and antimicrobial efficacy highlighted chitosan as a promising material for utilization in food preservation applications [10,11]. Notably, this eco-friendly preservative addresses the growing consumer demand for natural food preservation methods and provides a safer alternative to chemical-based additives.

The present application demonstrates that the introduction of lime particles into chitosan is a viable, efficient, and environmentally friendly preservative for fruit juice preservation. The amalgamation of these materials, characterized by a substantial intermolecular binding potential, often leads to a synergistic effect, capitalizing on individual advantages such as the anti-fermentation properties of Lime and the antimicrobial characteristics of chitosan. This application demonstrates the potential of Lime-incorporated Chitosan (LCh) as a food product preservative, particularly for fruit and vegetable juices. A comparative analysis was conducted to evaluate the protective effects of LCh against the commercial synthetic preservative sodium benzoate at its permissible limit of 1 g/kg GJ. The comprehensive assessment encompasses microbiological stability and various quality-related parameters, including color, pH, titratable acidity, concentrations of soluble solids, vitamin C, total phenolics, and antioxidant capacity, observed in GJ during storage at 25° C. Additionally, the reusability of the LCh beads for multiple preservation cycles further enhances their economic viability and sustainability, offering a significant advantage over traditional preservatives.

### BRIEF SUMMARY

An aspect of the present application is directed to a composition for food preservation comprising chitosan and calcium oxide (CaO; lime).

Another aspect of the present application is directed to a method for preserving a food product. Embodiments of the method comprise adding a composition for food preservation comprising chitosan and calcium oxide (CaO; lime), wherein the preserving comprises inhibiting at least one property selected from the group consisting of yeast and/or mold growth, pH change, acidity escalation, total soluble solids (TSS) formation, L-ascorbic acid change, alcohol generation, total phenolic content (TPC) fluctuation, total anthocyanin content (TAC) reduction, and antioxidant activity loss.

Another aspect of the present application is directed to a method for making a food preservation composition comprising chitosan and calcium oxide (CaO; lime). Embodiments of the method comprise to steps of adding chitosan powder to a solution comprising a binding agent to make a chitosan solution, wherein the binding agent is selected from hydrophilic polysaccharide, sodium alginate, agar agar, gellan gum, pectin, collagen, carrageenan, and xanthan gum; adding the chitosan solution dropwise to a calcium chloride (CaCl₂) solution; incubating the combined chitosan/CaCl₂ solution to allow the formation of lime-coated chitosan beads; filtering, rinsing, and drying the lime-coated chitosan beads; and drying the lime-coated chitosan beads.

### BRIEF DESCRIPTION OF THE DRAWINGS

The aspects of the present application can be better understood by reference to the following drawings. The drawings are merely exemplary to illustrate certain features that may be used singularly or in combination with other features and the present application should not be limited to the embodiments shown.

FIG. 1 depicts a visual image of the LCh beads, in accordance with embodiments of the disclosure.

FIG. 2A shows a scanning electron microscope (SEM) micrograph of the LCh beads, in accordance with embodiments of the disclosure.

FIG. 2B shows an SEM micrograph of the LCh beads, in accordance with embodiments of the disclosure at a higher magnification than FIG. 2A.

FIG. 2C shows an SEM micrograph of the LCh beads, in accordance with embodiments of the disclosure at a higher magnification than FIG. 2B.

FIG. 2D shows an EDX spectrum of the LCh beads, in accordance with embodiments of the disclosure.

FIG. 3A shows an XRD spectrum of the LCh beads, in accordance with embodiments of the disclosure.

FIG. 3B shows an FTIR spectrum of the LCh beads, in accordance with embodiments of the disclosure.

FIG. 4 shows the TPC profile of the Grape Juice (GJ) samples, in accordance with embodiments of the disclosure.

FIG. 5 shows the TAC profile of the GJ samples, in accordance with embodiments of the disclosure.

FIG. 6 depicts the antioxidant activity of the GJ samples, in accordance with embodiments of the disclosure.

FIG. 7 depicts the color characteristics of the GJ samples, in accordance with embodiments of the disclosure.

### DETAILED DESCRIPTION

The following detailed description is presented to enable any person skilled in the art to make and use the aspects of the present application. For purposes of explanation, specific nomenclature is set forth to provide a thorough understanding of the present application. However, it will be apparent to one skilled in the art that these specific details are not required to practice the aspects of the present application. Descriptions of specific applications are provided only as representative examples. The present application is not intended to be limited to the embodiments shown but is to be accorded the widest possible scope consistent with the principles and features disclosed herein. With respect to the teachings in the present application, any issued patent, pending patent application, patent application publication, or non-patent literature described in this application is expressly incorporated by reference herein.

Unless defined otherwise, all technical and scientific terms used herein have the same meanings as commonly understood by one of skill in the art to which the disclosed method and compositions belong. The phrase “as used herein” refers to the entire disclosure of this application, as well as to the appended claims.

As used herein, the singular forms “a,” “an,” and “the” include plural reference unless the context clearly dictates otherwise. Thus, for example, reference to “a preservative agent” includes “one or more” preservative agents or a “plurality” of such agents.

As used herein, the term “about” is used to provide flexibility to a number or a numerical range endpoint by providing that a given value may be within up to 10% of that number or endpoint without affecting the desired result. For example, “about 100” can refer to any number from 90 to 110 or a range of “90 to 110.” “About 50 to 100” or “about 50 to about 100” can refer to a range within “45 through 110.”

As used herein, recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure.

As used herein, unless the context clearly dictates otherwise, all embodiments of an aspect of the present application can be used singly or in any combination. As used herein, the term “comprising” dictates that additional embodiments of a claimed aspect beyond those recited in the claim may or may not be present, wherein those additional embodiments may or may not be described within the present disclosure. As used herein, the term “consisting of” dictates that that additional embodiments of a claimed aspect beyond those recited in the claim are excluded, wherein those additional embodiments may or may not be described within the present disclosure. As used herein, the phrase “consisting essentially of” dictates that additional embodiments of a claimed aspect beyond those recited in the claim may or may not be present and that their presence does not substantially affect the claim beyond the effects of the recited embodiment(s), wherein those additional embodiments may or may not be described within the present disclosure.

The innovative combination of Lime and Chitosan into beads represents a pioneering solution in the realm of food product, particularly fruit and vegetable juice, preservation, effectively addressing the challenges of microbial degradation, alcohol formation, and quality deterioration during storage. The dual action of these materials in synergistic bead form provides a multifunctional preservative solution that is both natural and environmentally friendly. Without being bound by theory, it is believed that this green and biocompatible preservative capitalizes on the inherent antimicrobial and adsorptive properties of Lime (CaO) and Chitosan, respectively, synergistically integrated into bead form. Also, the surprising and new features of this work lie in the synthesis simplicity and application of the LCh beads to fruit juice preservation as a substitute for hazardous synthetic chemical-based preservatives, thus presenting a holistic solution to the multifaceted challenges associated with fruit juice quality and stability.

The present application demonstrates the following surprising and unexpected results:
(a) The LCh beads exhibit a remarkable capacity to control microbial growth, providing a robust defense against yeasts and bacteria, including Staphylococcus and Bacillus. The antimicrobial efficacy of LCh beads is at least comparable to conventional synthetic preservatives such as sodium benzoate, ensuring the microbiological stability of fruit juices.
(b) An exceptional attribute of LCh beads is their ability to inhibit alcohol formation during storage. This is of paramount importance, aligning with consumer preferences for non-alcoholic fruit juices and contributing to the suitability of the juice for a broader consumer base.
(c) Preservation with LCh beads ensures the retention of fruit juice color, a critical aspect influencing consumer perception and acceptability. The beads demonstrate superior color retention compared to untreated samples and rival the performance of synthetic preservatives, particularly at an optimum loading of 5 wt. %.
(d) LCh beads effectively maintain essential physicochemical parameters, including pH, titratable acidity, total soluble solids, and L-ascorbic acid levels. This contributes to an extended shelf life of fruit juices while upholding their nutritional profile and sensory attributes.
(e) The beads exhibit a potent antioxidative capacity, sustaining total phenolic content, total anthocyanin content, and antioxidant activity. This ensures the preservation of the juice's nutritional quality and vibrant color over an extended storage period.

The introduction of LCh beads as a food product, such as juice, preservative, brings forth a host of advantages that underscore its superiority over conventional methods, spanning across microbiological, physicochemical, sensory, and consumer-centric dimensions. The beads present an eco-friendly alternative to hazardous synthetic preservatives, aligning with the contemporary demand for natural and sustainable food preservation methods. The innovative approach of fruit juice preservation using the LCh beads sets a new standard, offering a comprehensive and sustainable solution that caters to the evolving demands of consumers for fresh, safe, and naturally preserved food products. Notably, their non-dissolution nature facilitates their easy removal through filtration (post-treatment), unlike the compulsive consumption that happens with synthetic chemical preservatives, thus offering a healthy, user-friendly, and adaptable approach for juice storage.

A first aspect of the present application is directed to a composition for food preservation comprising chitosan and calcium oxide (CaO; lime).

In some embodiments, the composition further comprises a binding agent. In some further embodiments, the binding agent is a hydrophilic polysaccharide. In some still further embodiments, the hydrophilic polysaccharide is sodium alginate.

In some embodiments, the composition is formulated into beads.

A second aspect of the present application is directed to a method for preserving a food product, comprising adding a composition for food preservation comprising chitosan and calcium oxide (CaO; lime), wherein the preserving comprises inhibiting at least one property selected from the group consisting of yeast and/or mold growth, pH change, acidity escalation, total soluble solids (TSS) formation, L-ascorbic acid change, alcohol generation, total phenolic content (TPC) fluctuation, total anthocyanin content (TAC) reduction, and antioxidant activity loss.

In some embodiments, the food product comprises the juice of one or more fruits and/or vegetables. In some further embodiments, the one or more fruits are selected from the group consisting of grape, apple, pineapple, cranberry, raspberry, blueberry, cherry, orange, lemon, lime, grapefruit, prune, tomato, strawberry, cantaloupe, kiwi, papaya, pepper, pumpkin, and mango. In other further embodiments, the one or more vegetables are selected from the group consisting of carrot, celery, cucumber, ginger, beet, kale, cabbage, spinach, parsley, collard, wheatgrass, radicchio, broccoli, potato, and dandelion.

A third aspect of the present application is directed to a method for making a food preservation composition comprising chitosan and calcium oxide (CaO; lime) comprising: adding chitosan powder to a hydrophilic polysaccharide solution to make a chitosan solution; adding the chitosan solution dropwise to a calcium chloride (CaCl₂) solution; incubating the combined chitosan/CaCl₂ solution to allow the formation of lime-coated chitosan beads; filtering and rinsing the lime-coated chitosan beads; and drying the lime-coated chitosan beads.

In some embodiments, the hydrophilic polysaccharide is sodium alginate.

In some embodiments, the food preservation composition is formulated into beads.

### Lime-Incorporated Chitosan (LCh) Beads

Embodiments of the present application encompass LCh beads for food preservation. The beads comprise a synergistic combination of chitosan and calcium oxide (lime). Some embodiments are characterized by a formulation of chitosan powder and sodium alginate solution. This combination ensures optimal lime coating of the resultant beads and structural integrity.

Chitosan powder is introduced into a sodium alginate solution under controlled temperature and stirring conditions. Without being bound by theory, the chitosan:sodium alginate ratio has been optimized to ensure adequate gelation and bead formation while maintaining the structural integrity and functional properties of the beads. This ratio provides an optimal balance, ensuring that the chitosan is sufficiently encapsulated yet reactive enough to engage in its antimicrobial activity. In some embodiments, the ratio of chitosan to sodium alginate is within the range of 0.5-1.5 parts chitosan to 1.0-4.0 parts sodium alginate by weight. In some embodiments, the ratio of chitosan to sodium alginate is about 0.75:3.0 or greater by weight. In some embodiments, the ratio of chitosan to sodium alginate is about 1.0:2.0 or greater by weight. In some embodiments, the ratio of chitosan to sodium alginate is maintained at 1:2 by weight.

Simultaneously, a calcium chloride solution is prepared. The controlled addition of chitosan solution into the calcium chloride solution, followed by soaking and drying steps, yields the lime (CaO)-chitosan (LCh) beads. Without being bound by theory, the specific chitosan:lime ratio can be adjusted depending on the desired rate of release and antimicrobial potency. A higher lime content tends to increase the pH buffering capacity and enhances the antimicrobial properties, whereas a lower ratio emphasizes the physical properties and stability of the beads. In some embodiments, the ratio of chitosan to lime (Ch:CaO) is between about 3:1 and about 1:3 by weight. In some embodiments, the ratio of chitosan to lime is between about 2:1 and about 2:3 by weight, or between 1:0.5 and 1:1.5 by weight.

The surface coverage of lime on the chitosan beads is crucial for determining their preservation efficacy. In some embodiments, at least 40% of the bead's surface is covered with lime. In some embodiments, at least 50% of the bead's surface is covered with lime. In some embodiments, at least 60% of the bead's surface is covered with lime. In some embodiments, between about 40 and 100% of the bead's surface is covered with lime. In some embodiments, between about 50 and 90% of the bead's surface is covered with lime. Approximately 60-80% of the bead's surface area is preferably covered with lime. Without being bound by theory, this coverage ensures that there is enough lime exposed to effectively interact with microbial agents and contribute to pH adjustment, while still leaving sufficient chitosan exposed to maintain structural stability and enable its inherent bioactivity. The exact percentage can be tailored based on specific application needs, balancing between antimicrobial effectiveness and mechanical properties.

In some embodiments, the LCh beads may contain ingredients in addition to the chitosan, lime and sodium alginate. For example, the LCh beads may contain additional fillers, binding agents or colorants that are acceptable ingredients in food or pharmaceutical products. For example, fillers can be chosen for their inert nature, binding properties, and the ability to enhance structural integrity of the beads. Exemplary fillers may include but are not limited to microcrystalline cellulose (MCC) or calcium carbonate. Binding agents can be incorporated in addition to, or in place of, sodium alginate. Potential binding agents include, but are not limited to, agar agar, gellan gum, pectin, collagen, carrageenan, and xanthan gum. Agar agar offers similar gel-forming properties with the benefit of being a vegetarian option. Agar agar forms strong gels at lower concentrations, which could be advantageous in certain formulations. Gellan gum has excellent gel strength and stability, making it a suitable candidate for more rigorous processing conditions. Pectin is useful for its gel-forming capabilities in acidic conditions, potentially complementing the acidic nature of some fruit juices. Collagen could provide interesting structural properties and could be considered for specialized applications. Carrageenan is a seaweed-derived polysaccharide that forms robust gels that could act as an alternative to sodium alginate in certain formulations. Xanthan Gum is primarily used as a thickener, but can also act as a binder in lower concentrations and could be mixed with other gel-forming agents to achieve the desired consistency and functionality. Alternative and adjunct fillers and binding agents each have unique properties and potential applications. The choice of filler or binding agent would depend on the specific requirements of the preservation process, including the desired texture, mechanical strength, and release characteristics of the beads, as well as regulatory and consumer preference considerations.

Colorants may be incorporated into the LCh beads in order to make the beads easier to identify when mixed with a food product. In particular, the colorants are food-safe dyes. Such food-safe dyes may be plant/vegetable-based in the interest of maintaining the LCh beads as being an all-natural product.

In some embodiments, the LCh beads are between about 1 mm and about 15 mm in diameter. In some further embodiments, the LCh beads are between about 2 mm and about 10 mm in diameter. In some still further embodiments, the LCh beads are between about 3 mm and about 7 mm in diameter. In some embodiments, the LCh beads are about 1, 2, 3, 4, 5, 6, 7, 8, 9, 10, 11, 12, 13, 14 or 15 mm in diameter. The LCh beads can be spherical or irregular in shape. The LCh beads used in a particular preservative application in a food product can be uniform in size or of mixed sizes.

Scanning Electron Microscopy (SEM) coupled with Energy-Dispersive X-ray Spectroscopy (EDX) validates the present methods for the effective integration of lime particles onto the chitosan surface. X-ray Diffractometry (XRD) and Fourier-Transform Infrared (FTIR) Spectrometry confirm the structural and surface functionality features of the beads.

The LCh beads of the present application are suitable for preservations of foods having an aqueous component. In general, the LCh beads can provide effective preservation to foods having at least 10, 20, 30, 40, 50, 60, 70, 80, 90, 95, or 99% H₂O content. In particular, the LCh beads provide effective preservative properties to fruit and/or vegetable juices.

Food product preserving properties of the LCh beads include, but are not limited to:

Preservation of Physicochemical Parameters: The invention encompasses the LCh beads exhibit the capability to maintain the preservation of critical physicochemical parameters, including pH, titratable acidity, total soluble solids (TSS), and L-ascorbic acid with precision over an extended storage period.

In some embodiments, the pH change in food product comprising about 5 wt. % of the LCh beads over 21 days at 25° C. is less than about 3%.

In other embodiments, the change in titratable acidity in food product comprising about 5 wt. % of the LCh beads over 21 days at 25° C. is less than about 15%.

In some embodiments, the TSS formation in food product comprising about 5 wt. % of the LCh beads over 21 days at 25° C. is less than about 8%.

In some embodiments, the L-ascorbic acid change over 21 days at 25° C. is less than about 10% in food product comprising about 5 wt. % of the preservation composition.

Inhibition of Alcohol Formation: A distinctive embodiment involves the inhibition of alcohol formation in food products during storage. LCh beads demonstrate a pronounced ability to hinder alcohol formation, aligning with consumer preferences for non-alcoholic fruit juices.

In some embodiments, alcohol formation is about 64% lower than an untreated control over 21 days at 25° C. in food product comprising about 5 wt. % of the preservation composition.

Antioxidative Prowess and Color Retention: The invention highlights the antioxidative prowess of LCh beads, ensuring the sustained retention of total phenolic content (TPC), total anthocyanin content (TAC), and antioxidant activity. The beads exhibit an unprecedented ability to preserve the vibrant color of food products, such as fruit juices, over an extended storage duration.

In some embodiments, the loss of antioxidant activity in food product comprising about 5 wt. % of the LCh beads over 21 days at 25° C. is less than about 12%.

In some embodiments, the TPC loss in food product comprising about 5 wt. % of the LCh beads over 21 days at 25° C. is less than about 6%.

In some embodiments, the loss of TAC in food product comprising about 5 wt. % of the LCh beads over 21 days at 25° C. is less than about 3%.

Antimicrobial Action: An integral embodiment involves the potent antimicrobial action of LCh beads, inhibiting microbial growth and preventing food spoilage. Total Aerobic Plate Count and Yeast & Molds concentration studies validate the efficacy of LCh beads in ensuring microbiological stability.

Use of the LCh beads for the preservation of food products is versatile. In some embodiments, the beads can be immobilized on a substrate in a food storage container. In other embodiments, the beads can be contained within a permeable container, such as a mesh bag similar to what is commonly known as a tea bag. In still other embodiments the beads are loosely added to the food product.

In embodiments where the beads are not immobilized within a container, this application introduces a non-intrusive removal method for LCh beads. Unlike conventional preservatives, such as sodium benzoate, requiring consumption along with the food product, LCh beads can be easily removed from the food product by simple filtration or by removal of the permeable container from the food product, facilitating user-controlled preservation. The reusability of the beads for successive fruit juice preservation cycles demonstrated here underscores their extended functional lifespan, economic viability, and reduced environmental impact. Additionally, in embodiments where the beads are immobilized within a container, the container and beads can be washed and the efficacy of the beads regenerated for multiple cycles according to the methods herein. Thus, these beads maintain their preservation efficacy over multiple cycles, enhancing their sustainability and aligning with principles of green chemistry.

The concentration of LCh beads can be adjusted according to the properties of the food product being preserved. In some embodiments, the concentration of LCh beads by weight/weight (w/w) or weight/volume (w/v) is within the range of about 0.5% to about 25%. In some embodiments, the concentration of LCh beads by w/w or w/v is about 0.5%. In some embodiments, the concentration of LCh beads by w/w or w/v is about 1%. In some embodiments, the concentration of LCh beads by w/w or w/v is about 2%. In some embodiments, the concentration of LCh beads by w/w or w/v is about 5%. In some embodiments, the concentration of LCh beads by w/w or w/v is about 10%. In some embodiments, the concentration of LCh beads by w/w or w/v is about 15%. In some embodiments, the concentration of LCh beads by w/w or w/v is about 20%. In some embodiments, the concentration of LCh beads by w/w or w/v is about 25%. In particular embodiments, an ideal concentration of LCh beads in a juice product by w/w or w/v is between about 2.5% and about 15%. In further particular embodiments, an ideal concentration of LCh beads in a juice product by w/w or w/v is between about 5% and about 10%.

The present application demonstrates that the incorporation of LCh beads emerges as a promising avenue for non-toxic, environmentally friendly, and sustainable food product preservation, presenting a noteworthy alternative to traditional synthetic preservatives, such as sodium benzoate or potassium sorbate. This application, as exemplified by grape juice preservation, demonstrates the potential of LCh beads in countering microbial, enzymatic, and chemical deterioration, addressing the challenges that commonly shorten the shelf life of food products such as fruit juices. The synergistic effects of lime and chitosan components in LCh beads showcase enhanced antimicrobial efficacy, matching the performance of synthetic preservatives like sodium benzoate.

The present application provides the novel and surprising finding that utilization of LCh beads demonstrates a remarkable capacity to uphold the physicochemical attributes of food products during storage, encompassing pH, titratable acidity, total soluble solids, and L-ascorbic acid levels. In addition to preserving these quality attributes, LCh beads exhibit a surprisingly notable capacity to hinder alcohol formation during storage. This is a critical outcome, aligning with consumer preferences for non-alcoholic fruit juices and ensuring the juice's suitability for a broader consumer base. Further, the beads prove instrumental in preserving the quality and extending the shelf life of food products. With a notable capacity to maintain total phenolic content, total anthocyanin content, and antioxidant activity, LCh beads exhibit antioxidative prowess, sustaining the food product's nutritional profile and vibrant color. Simultaneously, these beads showcase potent antimicrobial action, inhibiting microbial growth and preventing food spoilage. The cumulative effect of these attributes positions LCh beads as a versatile and eco-friendly solution, ensuring the longevity of food product freshness and aligning with the contemporary demand for natural, preservative-free alternatives.

As exemplified herein, the preservation performances of grape juice using 5 wt. % and 10 wt. % LCh beads were observed to be on par with the performance achieved by 0.1 wt. % sodium benzoate, demonstrating the efficacy of LCh beads in maintaining the quality of the juice. Considering the comparable preservation performance between 5 wt. % and 10 wt. % LCh bead loadings, the reduced level of preservative concentration in fruit juice makes a 5 wt. % LCh loading particularly attractive. Thus, the superior preservative activity of LCh beads, as evidenced by the controlled microbial growth and alcohol inhibition, mitigated color changes, and maintained physicochemical parameters in grape juice, establishes these beads as an efficacious and sustainable alternative to synthetic preservatives. Compared to conventional preservatives like sodium benzoate, LCh beads demonstrate a notable advantage in preserving fruit juice quality, offering a green and biocompatible solution that aligns with the escalating consumer preference for natural and health-conscious food preservation methods. Notably, unlike synthetic preservatives (like sodium benzoate) that necessitate their compulsory consumption along with the juice due to their dissolution nature, the non-dissolution nature of the LCh beads in the fruit juice provides a convenient and non-intrusive removal method through filtration, facilitating a more adaptable and user-controlled approach to fruit juice preservation with a possible reusability of these beads for further preservation cycles.

This application underscores the substantial potential of Lime-incorporated chitosan (LCh) beads as a green and efficient preservative for fruit juice, showcasing their superiority in microbial control, alcohol inhibition, color retention, and maintenance of physicochemical parameters. These combined effects contribute to an extended shelf life while maintaining the sensory and nutritional integrity of the fruit juice over time. The exemplified preservative performance of grape juice samples loaded with 5 wt. % and 10 wt. % LCh beads exhibited an on-par preservation performance with synthetic sodium benzoate at its maximum permissible limit in fruit juices (0.1 wt. %). Notably, the comparable preservation efficacy between 5 wt. % and 10 wt. % LCh beads highlight the practical appeal of the former. Thus, in light of the growing concerns about the harmful effects of synthetic preservatives, LCh beads present an eco-friendly and biocompatible solution, aligning with the increasing consumer demand for fresh and safe foods without chemically synthesized additives.

The present application is further illustrated by the following examples which should not be construed as limiting. The contents of all references, patents and published patent applications cited throughout this application, as well as the Figures and Tables, are incorporated herein by reference.

### EXAMPLES

### Example 1—Materials, Bead and Sample Preparation, Experimental Plan

### Materials

Calcium chloride dihydrate (CaCl₂·2H₂O, 99%), chitosan (C₆H₁₁NO₄)n, sodium alginate, sodium hydroxide (NaOH, 98%), and sulfuric acid (H₂SO₄) were commercially procured from Sigma Aldrich, Germany. All other chemical reagents used for the necessary analytical characterization and food analysis were purchased from Fischer Scientific, Germany. Red grapes were purchased from LuLu hypermarket, Al Mushrif, Abu Dhabi, United Arab Emirates. Ultrapure water produced using Milli-Q IQ 7000 (Merck Millipore, US) with a conductivity of 0.05 S/cm at 25° C., TOC of 2 ppb, and pH of 6.99 was used for all aqueous applications.

### Preparation of LCh Beads:

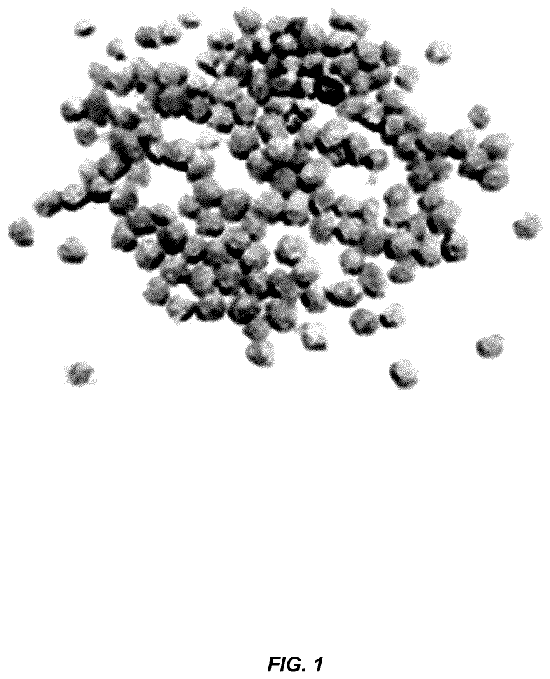

For the production of LCh beads, 4 g of chitosan powder was introduced into a thoroughly mixed solution comprising 200 mL of 2% sodium alginate. The system was heated to 60° C., with continuous stirring at 200 rpm. Concurrently, a solution of 0.1 M CaCl₂ was prepared and the chitosan solution was added dropwise, utilizing a burette, into the CaCl₂ solution while gently stirring to produce the desired lime-coated chitosan beads. These beads underwent a 24-hour soaking in the 0.1 M CaCl₂ solution, followed by filtration and thorough rinsing with deionized water. Subsequent steps involved air-drying the beads for 24 hours and subjecting them to drying in an oven at 70° C. for an hour to obtain the final product. A visual representation of the as-prepared LCh beads is provided in FIG. 1.

The analysis of the synthesized beads involved a comprehensive examination of their morphology, composition, and structural characteristics. The morphology and elemental composition of the beads were studied through scanning electron microscopy (SEM) equipped with energy-dispersive X-ray spectroscopy (EDX). The structural nature of the beads was examined by employing an X-ray diffractometer, while the functional groups within the beads were analyzed through Fourier-transform infrared (FTIR) spectrometry.

### Grape Juice Preservation Experiments:

Fresh grape juice (GJ) was obtained using a clean and disinfected fruit juicer, followed by filtration and mild pasteurization at 50° C. for 5 min. The resulting GJ samples were then divided into six equal portions, four of which were supplemented with 1%, 2%, 5%, and 10% (w/w) of LCh beads. For comparative purposes, two control sets were prepared—one open (preservative-free) control and another containing 0.1% sodium benzoate (NaBz). To ensure controlled incubation, all juice samples were placed in an incubator shaker at 25° C. for a period of 21 days, with aluminum foil wrapping employed to counteract photoactivity. Samples were extracted on Day 0, Day 7, Day 15, and Day 21 for the analysis of pH, titratable acidity, total soluble solids, ascorbic acid (METS-IP-104 method), and total alcohol content (METS-IP-82 method). Upon completion of the 21-day storage period, a comprehensive assessment was conducted, evaluating the chemical and biological attributes of the samples. Parameters such as color (using colorimeter), total phenolic content (using Folin-Ciocalteu method), total anthocyanin content (on the basis of cyanidin-3-glucoside), antioxidant activity (based on DPPH radical scavenging), aerobic plate count (ISO 4833-1 method), and yeast & molds (USFDA BAM method) concentration were examined. The entire experimental procedure was conducted in triplicate, and the resultant mean values, with their error bands, are reported.

### Example 2—Characterization of LCh Beads

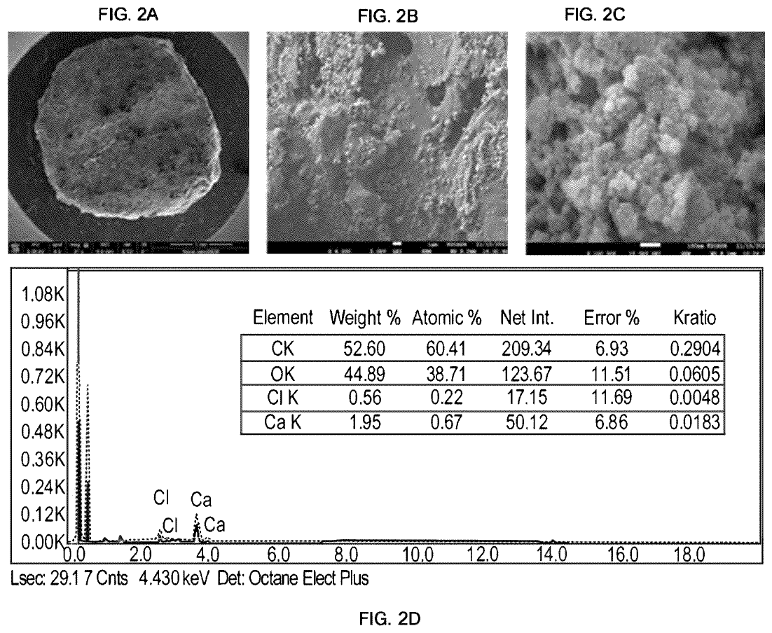

FIG. 2 provides SEM micrographs illustrating LCh beads, showcasing their initial size distribution in the range of 3-7 mm (FIG. 2A). Upon closer inspection at higher resolutions (FIGS. 2B and 2C), the micrographs reveal the effective integration of lime particles onto the chitosan surface, displaying noticeable agglomeration. The chemical composition and product purity of LCh beads were further assessed through EDX spectroscopy (FIG. 2D), where distinct peaks corresponding to C, Ca, and O confirm the successful incorporation of Lime (CaO) within the chitosan polymer network. Peaks attributed to Au and Cl were identified as background counts within the EDX detector.

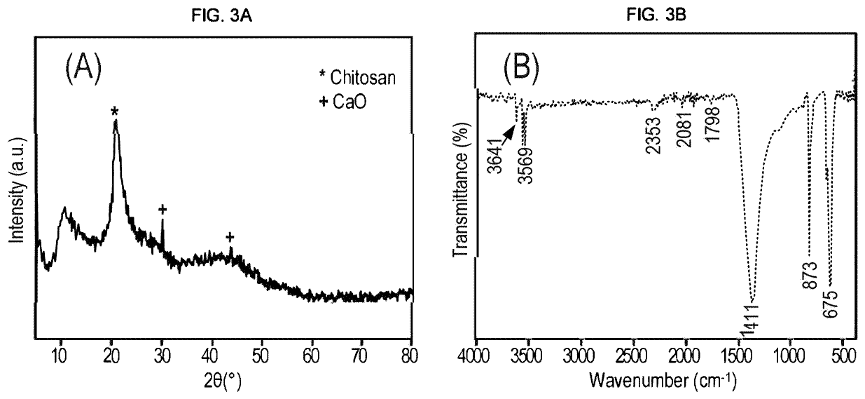

The investigation into the structural and surface attributes of LCh beads involved XRD and FTIR analyses. In the XRD spectrum (FIG. 3A), discernible peaks corresponding to chitosan structure at 20.5° (110 plane) were evident [12]. Peaks observed at 28.6° and 42.5° can be assigned to (111) and (202) planes of the cubic phase of CaO, as per JCPDS Card No. 00-037-1497, ICDD Card No. 00-017-0912, JCPDS File No. 37-1497, ICDD Card No 00-003-1123 [13]. This observation affirmed the successful doping of Lime onto the chitosan surface. In FIG. 3B, the FTIR spectrum spanning the wavenumber range of 4000 to 400 cm⁻¹ revealed characteristic bands at 675 and 873 cm⁻¹, indicative of Ca—O bonds and signifying the nano nature of lime particles formed on the chitosan surface [14]. Additionally, bands at 1798, 2081, and 2353 cm⁻¹ can be associated with O—H groups and C═O bonds within the beads [15]. The presence of chitosan peaks at 1411 and 3641 cm⁻¹ aligned with N—H and —NH₂ functional groups in its amine polymer chain, usually function as coordination and reaction sites. Notably, shifts in these functional groups' characteristic positions confirmed the successful binding of lime nanoparticles into the chitosan network [16].

### Example 3—Effect on Juice pH

The impact of pH on the flavor and preservation of various grape juice (GJ) samples was investigated, revealing a marginal reduction in pH levels across the GJ samples during the storage period, as detailed in Table 1. The untreated control sample exhibited the most significant pH change, registering at 9.1%, whereas samples laden with 1 wt. %, 2 wt. %, 5 wt. %, and 10 wt. % LCh beads experienced pH changes of 6.5%, 3.9%, 2.6%, and 1.3%, respectively. The incorporation of LCh beads demonstrated a discernible reduction in pH change, indicating a potential hindrance to sugar and organics degradation throughout the storage duration. Particularly noteworthy is the observation that pH change in the GJ sample loaded with 5 wt. % beads closely resembled the control sample loaded with 0.1 wt. % NaBz (2.6% change in pH) while the GJ sample loaded with 10 wt. % LCh beads outperformed the 0.1 wt. % NaBz.

TABLE 1
Effect of NaBz and LCh on the pH of Grape Juice

| | Storage Days | | | |
|---|---|---|---|---|
| Sample | 0 | 7 | 15 | 21 |
| Untreated | 3.85 ± 0 | 3.75 ± 0.05 | 3.6 ± 0.05 | 3.50 ± 0.1 |
| GJ + 0.1% | 3.85 ± 0 | 3.85 ± 0.1 | 3.75 ± 0.1 | 3.75 ± 0 |
| NaBz | | | | |
| GJ + 1% LCh | 3.85 ± 0 | 3.80 ± 0.05 | 3.7 ± 0.05 | 3.60 ± 0.1 |
| GJ + 2% LCh | 3.85 ± 0 | 3.80 ± 0.1 | 3.75 ± 0.05 | 3.70 ± 0.05 |
| GJ + 5% LCh | 3.85 ± 0 | 3.80 ± 0.05 | 3.75 ± 0.1 | 3.75 ± 0.1 |
| GJ + 10% LCh | 3.85 ± 0 | 3.85 ± 0.1 | 3.8 ± 0.05 | 3.80 ± 0.1 |

### Example 4—Effect on Juice Acidity

Acidity plays an important role in the flavor and taste of liquid products. Changes in titratable acidities of GJ during storage at 25° C. for 21 days are tabulated in Table 2. Results reveal dynamic changes in titratable acidities over time, with the untreated control sample exhibiting the highest increase at 82.4%. Conversely, samples incorporating 1 wt. %, 2 wt. %, 5 wt. %, and 10 wt. % LCh beads demonstrated relatively low changes of 20.6%, 17.6%, 14.7%, and 15.2%, respectively. The addition of LCh beads significantly lowered the acidity escalation, indicating its efficacy in suppressing microbial and enzymatic activities that catalyze fermentation and other chemical reactions within the juice. Specifically, the change in titratable acidity in GJ samples loaded with 5 wt. % LCh beads paralleled with the sample loaded with 0.1 wt. % NaBz.

TABLE 2
Effect of NaBz and LCh on Titratable
acidity (g/100 g GJ) of Grape Juice

| | Storage Days | | | |
|---|---|---|---|---|
| Sample | 0 | 7 | 15 | 21 |
| Untreated | 0.34 ± 0 | 0.41 ± 0.01 | 0.53 ± 0.02 | 0.62 ± 0.03 |
| GJ + 0.1% | 0.34 ± 0.02 | 0.34 ± 0.02 | 0.36 ± 0.01 | 0.38 ± 0.02 |
| NaBz | | | | |
| GJ + 1% LCh | 0.34 ± 0.02 | 0.38 ± 0.02 | 0.4 ± 0.02 | 0.41 ± 0.01 |
| GJ + 2% LCh | 0.34 ± 0.02 | 0.36 ± 0.01 | 0.39 ± 0.01 | 0.4 ± 0.02 |
| GJ + 5% LCh | 0.34 ± 0.02 | 0.36 ± 0.03 | 0.38 ± 0.01 | 0.39 ± 0.02 |
| GJ + 10% LCh | 0.33 ± 0.01 | 0.34 ± 0.02 | 0.37 ± 0.01 | 0.38 ± 0.01 |

### Example 5—Effect on Juice Total Soluble Solids

The quantitative representation of total soluble solids (TSS) in fruit juices is intricately linked to the specific parameters governing preservation. Examination of TSS alterations in GJ samples subjected to 21-day storage at 25° C. is presented in Table 3. A discernible trend emerges, with the untreated control sample manifesting the most substantial TSS change at 10.4%. Conversely, GJ samples augmented with 1 wt. %, 2 wt. %, 5 wt. %, and 10 wt. % LCh beads displayed comparatively reduced changes at 9%, 8.2%, 7%, and 8.3%, respectively. The introduction of LCh beads proved efficacious in curtailing the escalation of TSS in GJ, showcasing its dual capability to counteract evaporation and concentration phenomena while concurrently exerting control over microbial and enzymatic activities that instigate fermentation and other consequential chemical reactions.

TABLE 3
Effect of NaBz and LCh on Total Soluble
Solids (°Brix) of Grape Juice

| | Storage Days | | | |
|---|---|---|---|---|
| Sample | 0 | 7 | 15 | 21 |
| Untreated | 17.95 ± 0 | 18.75 ± 0.01 | 19.55 ± 0.02 | 19.82 ± 0.05 |
| GJ + 0.1% | 18.46 ± 0.01 | 18.74 ± 0.02 | 19.29 ± 0.03 | 19.41 ± 0.02 |
| NaBz | | | | |
| GJ + 1% LCh | 18.03 ± 0.02 | 18.82 ± 0.01 | 19.37 ± 0.05 | 19.65 ± 0.04 |
| GJ + 2% LCh | 18.09 ± 0.01 | 18.76 ± 0.03 | 19.21 ± 0.02 | 19.58 ± 0.03 |
| GJ + 5% LCh | 18.17 ± 0.03 | 18.69 ± 0.02 | 19.16 ± 0.01 | 19.44 ± 0.01 |
| GJ + 10% LCh | 18.11 ± 0.03 | 18.89 ± 0.02 | 19.39 ± 0.03 | 19.62 ± 0.02 |

### Example 6—Effect on Juice L-Ascorbic Acid Composition

The fluctuation in L-ascorbic acid composition within grape juice during storage is a complex interplay influenced by temperature, duration, and the presence of preservatives. This interplay significantly affects the juice's overall stability and antioxidant potential. Typically, the L-ascorbic acid content in fruit juices diminishes over storage due to oxidation, enzymatic degradation, and shifts in pH. Results for the L-ascorbic acid variation observed in this study for different GJ samples during the storage are given in Table 4. The untreated control sample experienced the most pronounced L-ascorbic acid change at 59.7%, whereas samples fortified with 1 wt. %, 2 wt. %, 5 wt. %, and 10 wt. % LCh beads demonstrated comparatively lower changes at 27.3%, 20.4%, 10.9%, and 15%, respectively. Noteworthy is the discernible role of LCh beads in preserving L-ascorbic acid in GJ samples, with the 5 wt. % LCh loaded sample exhibiting proximity to the 0.1 wt. % NaBz loaded control sample (10.7% change in L-ascorbic acid).

TABLE 4
Effect of NaBz and LCh on Ascorbic acid
content (mg/100 mL GJ) of Grape Juice

| | Storage Days | | | |
|---|---|---|---|---|
| Sample | 0 | 7 | 15 | 21 |
| Untreated | 17.95 ± 0.03 | 18.75 ± 0.02 | 19.55 ± 0.15 | 19.82 ± 0.19 |
| GJ + 0.1% | 18.46 ± 0.14 | 18.74 ± 0.05 | 19.29 ± 0.04 | 19.41 ± 0.08 |
| NaBz | | | | |
| GJ + 1% LCh | 18.03 ± 0.09 | 18.82 ± 0.07 | 19.37 ± 0.1 | 19.65 ± 0.05 |
| GJ + 2% LCh | 18.09 ± 0.06 | 18.76 ± 0.04 | 19.21 ± 0.03 | 19.58 ± 0.07 |
| GJ + 5% LCh | 18.17 ± 0.05 | 18.69 ± 0.06 | 19.16 ± 0.08 | 19.44 ± 0.11 |
| GJ + 10% LCh | 18.11 ± 0.02 | 18.89 ± 0.04 | 19.39 ± 0.05 | 19.62 ± 0.06 |

### Example 7—Effect on Juice Alcohol Content

The total alcohol content in grape juice experiences dynamic changes during storage, influenced by factors such as time, temperature, and the presence of preservatives, with consequential effects on the sensory profile, product stability, and overall consumer acceptability of the juice. In the context of citrus juices, there is a general trend of increased total alcohol content during storage, attributed to yeast fermentation and microbial activities. Results for the total alcohol content variations in different GJ samples are specified in Table 5. A very high total alcohol content was observed in the untreated control sample that recorded a most substantial change of 303%. Conversely, GJ samples treated with 1 wt. %, 2 wt. %, 5 wt. %, and 10 wt. % LCh beads exhibited reduced changes in total alcohol content at 170%, 93.5%, 44.8%, and 41.7%, respectively. Remarkably, the incorporation of LCh beads exhibited a pronounced inhibitory effect on yeast fermentation and microbial activities, consequentially alleviating the rise in total alcohol content in GJ samples. This effect was particularly noteworthy in the 5 wt. % and 10 wt. % LCh loaded samples that lowered the alcohol formation by 64% compared to the untreated control and showcased a close alignment with the 0.1 wt. % NaBz loaded control sample (41.7% change in total alcohol content).

TABLE 5
Effect of NaBz and LCh on Total alcohol
content (%) of Grape Juice

| | Storage Days | | | |
|---|---|---|---|---|
| Sample | 0 | 7 | 15 | 21 |
| Untreated | 2.31 ± 0 | 3.63 ± 0.07 | 6.84 ± 0.14 | 9.27 ± 0.19 |
| GJ + 0.1% NaBz | 2.32 ± 0.1 | 2.44 ± 0.04 | 3 ± 0.05 | 3.21 ± 0.05 |
| GJ + 1% LCh | 2.31 ± 0 | 3.01 ± 0.09 | 5.23 ± 0.16 | 6.21 ± 0.19 |
| GJ + 2% LCh | 2.31 ± 0.1 | 2.73 ± 0.05 | 4.03 ± 0.08 | 4.45 ± 0.09 |
| GJ + 5% LCh | 2.31 ± 0.1 | 2.57 ± 0.06 | 3.06 ± 0.08 | 3.33 ± 0.06 |
| GJ + 10% LCh | 2.31 ± 0.1 | 2.42 ± 0.04 | 2.96 ± 0.05 | 3.26 ± 0.08 |

### Example 8—Effect on Juice Total Phenolic Content

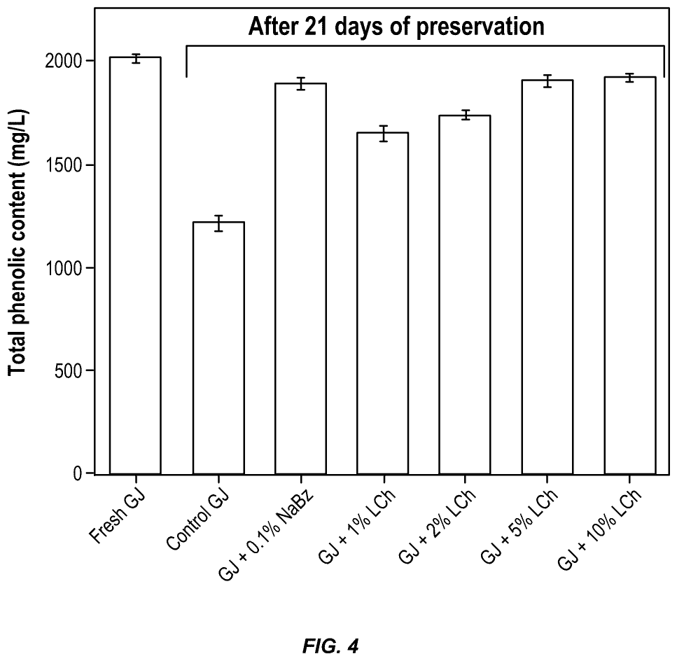

The Total Phenolic content (TPC) in fruit juice plays a pivotal role in its antioxidant properties, influencing sensory attributes and potential health benefits. Understanding the variations in TPC during storage is crucial for evaluating the effectiveness of preservation conditions. A substantial TPC fluctuation indicates the degradation of natural bioactives in the juice, leading to a distinct decline in the quality and safety of the food product [17]. FIG. 4 illustrates the TPC values of fresh and treated GJ samples at the end of a 21-day storage period. The untreated control sample experienced the highest TPC loss at 39.6%, while samples treated with 1 wt. %, 2 wt. %, 5 wt. %, and 10 wt. % LCh beads demonstrated reduced losses at 18.1%, 13.7%, 5.5%, and 4.7%, respectively. The incorporation of LCh beads emerges as a significant preservative strategy, particularly evident in the 5 wt. % and 10 wt. % LCh loaded samples, surpassing the preservative activity of 0.1 wt. % NaBz, which recorded a 6.2% change in TPC value.

### Example 9—Effect on Juice Total Anthocyanin Content

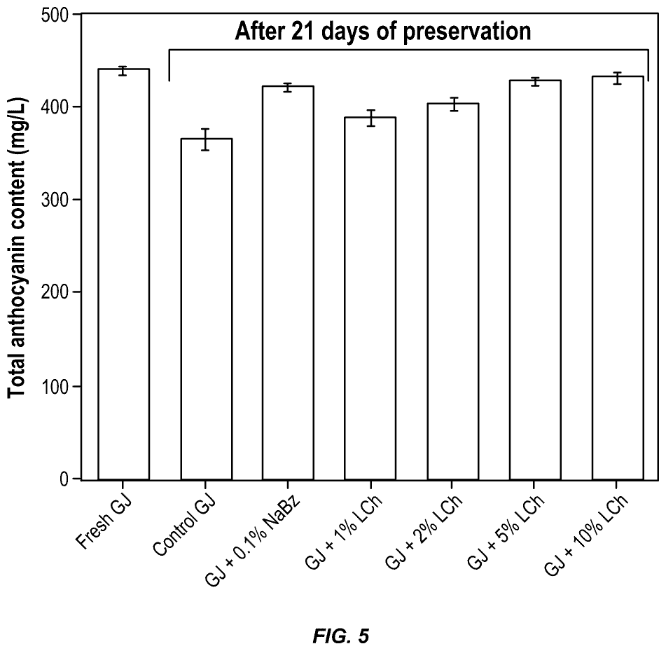

The Total Anthocyanin Content (TAC) in fruit juice is pivotal for color stability, sensory appeal, and potential health benefits, with variations during storage providing insights into its impact on aesthetic quality and nutritional profile. A larger variation in TAC during storage indicates potential pigment degradation, affecting color stability, sensory appeal, and health benefits [18]. FIG. 5 provides information on TAC values in fresh and treated GJ samples after a 21-day storage period. Notably, the untreated control sample exhibited the highest TAC loss at 16.9%, whereas treated samples with 1 wt. %, 2 wt. %, 5 wt. %, and 10 wt. % LCh beads displayed mitigated losses at 11.6%, 8.2%, 2.7%, and 1.8%, respectively. The strategic inclusion of LCh beads emerges as a significant preservative measure, particularly evident in the 5 wt. % and 10 wt. % LCh loaded samples, outperforming the performance of the 0.1 wt. % NaBz, which recorded a 4.1% change in TAC value.

### Example 10—Effect on Juice Antioxidant Activity

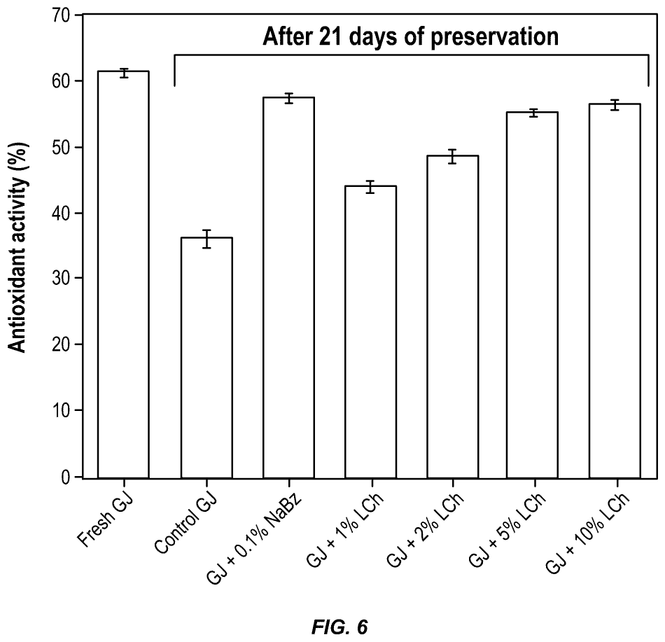

The antioxidant activity in fruit juices relies on the presence and composition of bioactive compounds such as vitamin C, carotenoids, and flavanones. This activity reflects the juice's ability to counteract oxidative stress, preserving sensory qualities and potential health benefits [18]. The sustained retention of antioxidant activity during juice storage indicates the preservation method's ability to uphold oxidative stability, thereby contributing to the juice's lasting sensory appeal and nutritional value. FIG. 6 depicts the DPPH radicals scavenging-based antioxidant activity in fresh and treated GJ samples after a 21-day storage. The untreated control sample showcased the highest antioxidant activity loss at 41.1%, while all GJ samples treated with 1 wt. %, 2 wt. %, 5 wt. %, and 10 wt. % LCh beads displayed substantially lower losses of antioxidant activity at 28.4%, 20.7%, 10%, and 7.8%, respectively. Specifically, samples treated with higher LCh concentrations (5 wt. % and 10 wt. %) showed an antioxidant activity loss of ≤10%, aligning with the performance of the 0.1 wt. % NaBz GJ sample, which recorded a 6.4% loss in antioxidant activity.

### Example 11—Effect on Juice Microbial Content

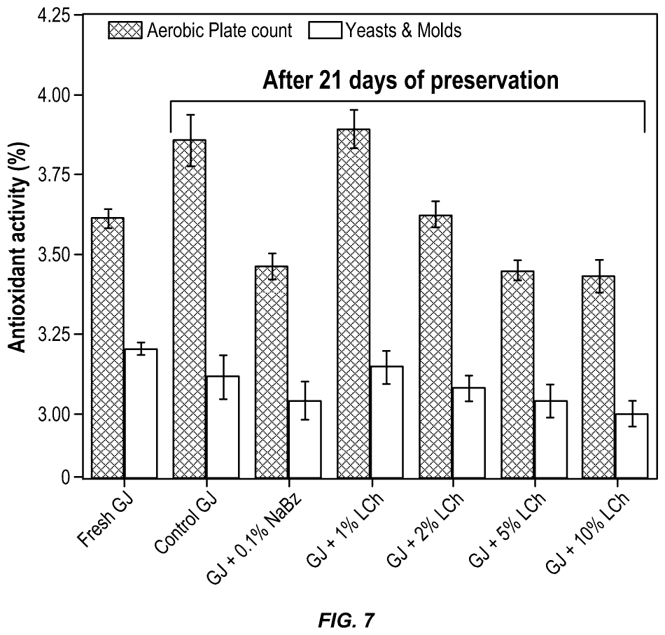

The preservation of fruit juice quality and safety heavily relies on the pivotal antimicrobial potential of preservatives, acting as a crucial defense mechanism against microbial deterioration and contributing to an extended shelf life [19]. Sodium benzoate and Potassium sorbate, commonly used chemical preservatives in the food industry, have demonstrated efficacy against yeasts and bacteria, including Staphylococcus and Bacillus. However, their excessive use (>0.1 wt. %) poses significant risks to both human health and the environment [20]. The study's results, illustrated in FIG. 7, reveal the antimicrobial potential under various preservation conditions. A progressive reduction in the Total Aerobic Plate Count and Yeast & Molds with incremental loadings of LCh beads in grape juice samples was observed, except at 1 wt. % loading, indicating its insufficient induction of antimicrobial activity. Remarkably, the antimicrobial efficacy of 5 wt. % and 10 wt. % LCh loaded samples paralleled the performance of 0.1 wt. % NaBz.

### Example 12—Effect on Juice Color

The color of fruit juice holds significant importance in shaping consumer perception and acceptability, with color retention during storage playing a crucial role in ensuring visual appeal, freshness, and quality. Preserving the color integrity is vital for enhancing the juice's overall sensory experience and marketability. Fruit juice preservatives are pivotal in maintaining color integrity, preventing deterioration and discoloration, ultimately ensuring consumer acceptability. Table 6 summarizes the color parameter measurements and the change in color (ΔE) of various GJ samples with and without preservatives. Notably, GJ samples preserved with NaBz and LCh beads exhibit significantly reduced color changes compared to the untreated sample. The 5 wt % LCh beads, in particular, demonstrate color retention performance comparable to the effect of 0.1 wt % NaBz.

TABLE 6
Effect of NaBz and LCh on color change of Grape Juice

| | | | | Change in |
|---|---|---|---|---|
| | L* | a* | b* | color (ΔE) |
| Fresh GJ | 18.21 ± 0 | 0.24 ± 0 | 2.72 ± 0 | 0 |
| Untreated | 14.57 ± 0.93 | −0.77 ± 0.05 | 3.09 ± 0.07 | 3.795603 |
| GJ + 0.1% NaBz | 18.25 ± 0.54 | 0.2 ± 0.07 | 2.66 ± 0.03 | 0.374299 |
| GJ + 5% LCh | 18.11 ± 0.62 | 0.18 ± 0.04 | 2.89 ± 0.06 | 0.387943 |

(ΔE = \sqrt{ΔL* + Δa* + Δb*})

### Example 13—Removal and Reusability of LCh Beads

Reusability studies of the LCh beads involved their regeneration prior to their use in a new preservation cycle. After each preservation cycle, the spent LCh beads were filtered from the juice, thoroughly washed with water to remove residual contaminants, and then air-dried for 24 hours followed by oven drying at 70° C. for an hour. This simple regeneration procedure enabled the reuse of the beads for multiple preservation cycles, ensuring consistent performance and sustained efficacy.

The reusability of LCh beads for fruit juice preservation is valuable for their economic viability and sustainability. Employing the beads for multiple preservation cycles ensures optimized resource utilization, significantly reduce production costs, and extend the functional lifespan of the beads. The reusability of the beads underscores their preservation efficacy, aligning with green chemistry principles and reducing environmental impact. Moreover, integrating a regeneration process enhances practicality, scalability, and minimizes waste. Tables 7 and 8 show the results for the reusability studies of LCh beads for a 5 wt. % loading. The reusability studies of LCh beads reveal their consistent performance for up to three cycles of fruit juice preservation. Studies revealed that after two recycles, the beads demonstrated a marginal 10% reduction in preservation efficacy. However, regenerating the LCh beads after three cycles resulted in a substantial loss (>10%) in their preservation performance for subsequent juice preservation, indicating their efficiency for up to three preservation cycles. Thus, the reusability study underscores the efficacy of LCh beads for multiple preservation cycles, demonstrating their consistent performance for up to three cycles while maintaining the quality parameters of stored fruit juice samples.

TABLE 7
Reusability of LCh beads - Physicochemical Characteristics of Grape Juice

| | LCh Beads | | | |
|---|---|---|---|---|
| Characteristic | Fresh | 1^{st} Re-use | 2^{nd} Re-use | 3^{rd} Re-use |
| | Grape Juice Sample at Start of Incubation | | | |
| pH | 3.85 ± 0 | 3.8 ± 0.05 | 3.85 ± 0 | 3.85 ± 0 |
| TiA (g ± 100 g) | 0.34 ± 0 | 0.34 ± 0 | 0.34 ± 0.02 | 0.33 ± 0.02 |
| TSS (°Brix) | 17.95 ± 0 | 17.94 ± 0.01 | 17.95 ± 0 | 17.92 ± 0.02 |
| LAA (mg ± 100 ml) | 6.53 ± 0 | 6.51 ± 0.02 | 6.55 ± 0.01 | 6.54 ± 0 |
| TAcC (%) | 2.31 ± 0 | 2.33 ± 0.01 | 2.32 ± 0 | 2.32 ± 0 |
| | Grape Juice Sample at 21 Days of Incubation (5 wt. % LCh Beads) | | | |
| pH | 3.75 ± 01 | 3.7 ± 0.05 | 3.65 ± 0.01 | 3.55 ± 0.05 |
| TiA (g ± 100 g) | 0.39 ± 0.02 | 0.4 ± 0.04 | 0.43 ± 0.03 | 0.52 ± 0.07 |
| TSS (°Brix) | 19.44 ± 0.01 | 19.49 ± 0.02 | 19.56 ± 0.04 | 19.71 ± 0.03 |
| LAA (mg ± 100 ml) | 5.82 ± 0.09 | 5.61 ± 0.11 | 5.32 ± 0.07 | 4.91 ± 0.01 |
| TAcC (%) | 3.33 ± 0.06 | 3.41 ± 0.11 | 3.73 ± 0.07 | 5.39 ± 0.08 |

TiA—Titratable Acidity;
TSS—Total Soluble Solids;
LAA—L-ascorbic acid;
TAcC—Total Alcohol Content

TABLE 8
Reusability of LCh beads - Quality Parameters of Grape Juice

| | LCh Beads | | | |
|---|---|---|---|---|
| Parameter | Fresh | 1^{st} Re-use | 2^{nd} Re-use | 3^{rd} Re-use |
| | Grape Juice Sample at Start of Incubation | | | |
| TPC (mg/l) | 2015 ± 18 | 2018 ± 20 | 2010 ± 16 | 2012 ± 22 |
| TAC (mg/l) | 439 ± 4 | 436 ± 6 | 430 ± 11 | 444 ± 7 |
| AA (%) | 61.3 ± 0.5 | 60.6 ± 0.6 | 62.2 ± 0.8 | 60.9 ± 0.4 |
| APC (log(cfu/ml)) | 3.613 ± 0.03 | 3.629 ± 0.04 | 3.602 ± 0.05 | 3.615 ± 0.02 |
| | Grape Juice Sample at 21 Days of Incubation (5 wt. % LCh Beads) | | | |
| TPC (mg/l) | 1905 ± 28 | 1865 ± 19 | 1827 ± 22 | 1764 ± 11 |
| TAC (mg/l) | 427 ± 5 | 412 ± 7 | 401 ± 4 | 386 ± 6 |
| AA (%) | 55.2 ± 0.6 | 52.4 ± 0.9 | 49.3 ± 0.7 | 42.4 ± .1 |
| APC (log(cfu/ml)) | 3.447 ± 0.03 | 3.491 ± 0.03 | 3.544 ± 0.03 | 3.591 ± 0.03 |
| | ΔE | | | |
| | 0.388 | 0.431 | 0.516 | 0.768 |

TPC—Total Phenolic Content;
TAC—Total Anthocyanin Content;
AA—Antioxidant Activity;
APC—Aerobic Plate Count

Also, no fruit preservative to date has demonstrated reusability, marking LCh beads as pioneers in this regard. This unique feature distinguishes LCh beads as trailblazers in the field, setting a precedent for sustainable and economically viable fruit preservation methodologies.

### REFERENCES

1. Ephrem, E., Najjar, A., Charcosset, C. and Greige-Gerges, H., 2018. Encapsulation of natural active compounds, enzymes, and probiotics for fruit juice fortification, preservation, and processing: An overview. Journal of Functional Foods, 48, pp. 65-84.
2. Aneja, K. R., Dhiman, R., Aggarwal, N. K. and Aneja, A., 2014. Emerging preservation techniques for controlling spoilage and pathogenic microorganisms in fruit juices. International journal of microbiology, 2014.
3. Avîrvarei, A. C., Salanţă, L. C., Pop, C. R., Mudura, E., Pasqualone, A., Anjos, O., Barboza, N., Usaga, J., Dărab, C. P., Burja-Udrea, C. and Zhao, H., 2023. Fruit-based fermented beverages: contamination sources and emerging technologies applied to assure their safety. Foods, 12(4), p. 838.
4. Morata, A., Loira, I., Vejarano, R., González, C., Callejo, M. J. and Suárez-Lepe, J. A., 2017. Emerging preservation technologies in grapes for winemaking. Trends in Food Science & Technology, 67, pp. 36-43.
5. Adhikari, S., 2021. Additives and Preservatives Used in Food Processing and Preservation, and Their Health Implication. Food Chemistry: The Role of Additives, Preservatives and Adulteration, pp. 43-72.
6. Pina-Pérez, M., Rodrigo, D. and Martinez, A., 2015. Using natural antimicrobials to enhance the safety and quality of fruit- and vegetable-based beverages. Handbook of natural antimicrobials for food safety and quality, pp. 327-345.
7. Zhang, J., Zheng, B., Zhang, C., Xie, L. and Fang, C., Calcined waste shells as a promising, eco-friendly adsorbent, antimicrobial, food preservative, and food packaging material: A mini review. Journal of Food Process Engineering, p. e14477.
8. Sadeghi, K., Thanakkasaranee, S., Lim, I. J. and Seo, J., 2020. Calcined marine coral powders as a novel ecofriendly antimicrobial agent. Materials Science and Engineering: C, 107, p. 110193.
9. Sarma, C., Mummaleti, G., Sivanandham, V., Kalakandan, S., Rawson, A. and Anandharaj, A., 2022. Anthology of palm sap: The global status, nutritional composition, health benefits & value added products. Trends in Food Science & Technology, 119, pp. 530-549.
10. Liu, X., Liao, W. and Xia, W., 2023. Recent advances in chitosan based bioactive materials for food preservation. Food Hydrocolloids, p. 108612.
11. Chen, Y., Liu, Y., Dong, Q., Xu, C., Deng, S., Kang, Y., Fan, M. and Li, L., 2023. Application of functionalized chitosan in food: A review. International Journal of Biological Macromolecules, p. 123716.
12. Liu, M., Zhou, Y., Zhang, Y., Yu, C. and Cao, S., 2013. Preparation and structural analysis of chitosan films with and without sorbitol. Food Hydrocolloids, 33(2), pp. 186-191.
13. Sinha, S., Aman, A. K., Singh, R. K., Kr, N. and Shivani, K., 2021. Calcium oxide (CaO) nanomaterial (Kukutanda twak Bhasma) from egg shell: Green synthesis, physical properties and antimicrobial behaviour. Materials Today: Proceedings, 43, pp. 3414-3419.
14. Roy, A. and Bhattacharya, J., 2011. Microwave-assisted synthesis and characterization of CaO nanoparticles. International Journal of Nanoscience, 10(03), pp. 413-418.
15. Galván-Ruiz, M., Hernández, J., Baños, L., Noriega-Montes, J. and Rodríguez-García, M. E., 2009. Characterization of calcium carbonate, calcium oxide, and calcium hydroxide as starting point to the improvement of Lime for their use in construction. Journal of Materials in Civil Engineering, 21(11), pp. 694-698.
16. Ikram, M., Muhammad Khan, A., Haider, A., Haider, J., Naz, S., Ul-Hamid, A., Shahzadi, A., Nabgan, W., Shujah, T., Shahzadi, I. and Ali, S., 2022. Facile synthesis of La- and chitosan-doped CaO nanoparticles and their evaluation for catalytic and antimicrobial potential with molecular docking studies. ACS omega, 7(32), pp. 28459-28470.
17. Mena, P., Vegara, S., Martí, N., García-Viguera, C., Saura, D. and Valero, M., 2013. Changes on indigenous microbiota, colour, bioactive compounds and antioxidant activity of pasteurised pomegranate juice. Food Chemistry, 141(3), pp. 2122-2129.
18. Yang, W., Wu, Z., Huang, Z. Y. and Miao, X., 2017. Preservation of orange juice using propolis. Journal of Food Science and Technology, 54, pp. 3375-3383.
19. Fuciños, C., Fuciños, P., Fajardo, P., Amado, I. R., Pastrana, L. M. and Rua, M. L., 2015. Evaluation of antimicrobial effectiveness of pimaricin-loaded thermosensitive nanohydrogels in grape juice. Food and Bioprocess Technology, 8, pp. 1583-1592.
20. Rupasinghe, H. V. and Yu, L. J., 2012. Emerging preservation methods for fruit juices and beverages. Food additive, 22, pp. 65-82.

The above description is for the purpose of teaching the person of ordinary skill in the art how to practice the aspects of the present application, and it is not intended to detail all those obvious modifications and variations of it which will become apparent to the skilled worker upon reading the description. It is intended, however, that all such obvious modifications and variations be included within the scope of the present invention, which is defined by the following claims. The claims are intended to cover the claimed components and steps in any sequence which is effective to meet the objectives there intended, unless the context specifically indicates the contrary.

What is claimed is:

1. A composition for food preservation comprising chitosan and calcium oxide (CaO; lime).

2. The composition of claim 1, further comprising a binding agent.

3. The composition of claim 2, wherein the binding agent is a hydrophilic polysaccharide.

4. The composition of claim 3, wherein the hydrophilic polysaccharide is sodium alginate.

5. The composition of claim 2, wherein the composition is formulated into spherical or irregular-shaped beads, with the bead diameter ranging from about 1 mm to about 15 mm.

6. A method for preserving a food product, comprising adding a composition for food preservation comprising chitosan and calcium oxide (CaO; lime), wherein the preserving comprises inhibiting at least one property selected from the group consisting of yeast and/or mold growth, pH change, acidity escalation, total soluble solids (TSS) formation, L-ascorbic acid change, alcohol generation, total phenolic content (TPC) fluctuation, total anthocyanin content (TAC) reduction, and antioxidant activity loss.

7. The method of claim 6, wherein the food product comprises the juice of one or more fruits and/or vegetables.

8. The method of claim 6, wherein the pH change over 21 days at 25° C. is less than about 3% in food product comprising about 5 wt. % of the preservation composition.

9. The method of claim 6, wherein the acidity escalation over 21 days at 25° C. is less than about 15% in food product comprising about 5 wt. % of the preservation composition.

10. The method of claim 6, wherein the TSS formation over 21 days at 25° C. is less than about 8% in food product comprising about 5 wt. % of the preservation composition.

11. The method of claim 6, wherein the L-ascorbic acid change over 21 days at 25° C. is less than about 10% in food product comprising about 5 wt. % of the preservation composition.

12. The method of claim 6, wherein alcohol formation is at least 64% lower than an untreated control over 21 days at 25° C. in food product comprising about 5 wt. % of the preservation composition.

13. The method of claim 6, wherein the TPC loss over 21 days at 25° C. is less than about 6% in food product comprising about 5 wt. % of the preservation composition.

14. The method of claim 6, wherein the loss of TAC over 21 days at 25° C. is less than about 3% in food product comprising about 5 wt. % of the preservation composition.

15. The method of claim 6, wherein the loss of antioxidant activity over 21 days at 25° C. is less than about 12% in food product comprising about 5 wt. % of the preservation composition.

16. The method of claim 6, wherein the lime-coated chitosan beads preserve the color stability of the food product by reducing the total color change (ΔE) by less than about 0.5 units over 21 days at 25° C. in food product comprising about 5 wt. % of the preservation composition.

17. The method of claim 6, wherein the lime-coated chitosan beads demonstrate antimicrobial efficacy by reducing Total Aerobic Plate Count and yeast & mold concentration by at least 50% over a 21-day period at 25° C.

18. A method for preserving a food product, wherein the lime-coated chitosan beads can be regenerated through water washing, air-drying, and oven-drying at 70° C., and reused for up to three fruit juice preservation cycles with no more than a 10% loss in preservation efficacy after two cycles.

19. The method of claim 6, wherein the lime-coated chitosan beads are removed after preservation using a simple filtration or sieving process, without dissolving in the food product.

20. A method for making a food preservation composition comprising chitosan and calcium oxide (CaO; lime) comprising:
a) adding chitosan powder to a solution comprising a binding agent to make a chitosan solution, wherein the binding agent is selected from hydrophilic polysaccharide, sodium alginate, agar agar, gellan gum, pectin, collagen, carrageenan, and xanthan gum;
b) adding the chitosan solution dropwise to a calcium chloride (CaCl₂) solution;
c) incubating the combined chitosan/CaCl₂ solution to allow the formation of lime-coated chitosan beads;
d) filtering, rinsing, and drying the lime-coated chitosan beads; and
e) drying the lime-coated chitosan beads.
